(19) United States
(12) Patent Application Publication
(10) Pub. No.: US 2024/0136951 A1
(43) Pub. Date: Apr. 25, 2024

(54) PREDICTIVE-CONTROL BASED LOW-VOLTAGE-RIDE-THROUGH METHOD FOR A GRID-TIED INVERTER

(71) Applicant: The Florida State University Research Foundation, Inc., Tallahassee, FL (US)

(72) Inventors: Hui Li, Tallahassee, FL (US); Xiaofeng Dong, Tallahassee, FL (US)

(21) Appl. No.: 18/373,751

(22) Filed: Sep. 27, 2023

Related U.S. Application Data
(60) Provisional application No. 63/416,206, filed on Oct. 14, 2022.

(51) Int. Cl. H02M 7/539; H02J 3/00

(52) U.S. Cl. CPC H02M 7/539; H02J 3/00; H02J 2203/20

(57) ABSTRACT

Systems, devices, and methods are described herein that facilitate using predictive-control based LVRT methods for grid-tied inverters.

### CROSS-REFERENCE TO RELATED APPLICATION

This application claims priority to and benefit of U.S. provisional patent application Ser. No. 63/416,206 filed Oct. 14, 2022, which is fully incorporated by reference.

### BACKGROUND

Previous low-voltage-ride-through (LVRT) methods for grid-tied inverters all require voltage sensors with fast low-voltage detection circuits to detect the voltage conditions on the ac grid. Under the condition of steady-state operation of grid-tied inverter, additional hardware circuits and specially designed LVRT control unit are needed to perform the LVRT. In addition, inrush currents and oscillations are inevitable during the LVRT process due to the limitation of the controller characteristics and control bandwidth. Therefore, previous LVRT approaches not only increase the system cost and control complexity, but also have limited dynamic performance of LVRT.

The LVRT or zero-voltage-ride-through (ZVRT) of phase lock loop (PLL)-less grid-tied inverters has not been investigated. On the other hand, silicon carbide (SiC) grid-tied inverters have increased growing applications where a small L filter can replace LCL filter due to their fast switching frequency. However, this small L filter may result in high inrush current during ZVRT, which poses more control challenges for a self-synchronizing grid-tied inverter without PLL and voltage sensors. A small L filter may also cause more challenges for LVRT control.

Model predictive control (MPC) methods have been applied to the grid-tied inverters with LCL filter to achieve good performance. SiC grid-tied inverters have increased applications recently due to its higher efficiency, higher power density and lower system cost compared to their Si-counterparts. Since SiC devices can switch at high frequency, LCL filter size can be reduced or even replaced by a small L, which lead to control benefits such as no LCL resonance issue and allows high control bandwidth. However, when traditional MPC method has been applied to SiC inverter with L filter, it may suffer current harmonics.

Therefore, systems, methods and devices are desired that overcome challenges in the art, some of which are described above. In particular, control methods and system for LVRT and ZVRT are desired for grid-tied inverters having LCL filters or small L filters.

### SUMMARY

Systems, devices, and methods are described herein that facilitate using predictive-control based LVRT methods for grid-tied inverters. One method comprises a Finite-Control-Set Model-Predictive-Control or FCS-MPC based LVRT method, another method comprises a deadbeat control based LVRT method. Both methods are able to predict the grid voltage. Therefore, no voltage sensor is required to detect the voltage condition on the ac grid. In addition, the future currents are estimated, and the future output voltage vectors/references and the switching signals of the inverter are generated by the developed discrete-time model to achieve fast dynamic control performance. As a result, the current overshoots and oscillations can be greatly reduced during the LVRT process, which significantly improves the reliability of the grid-tied inverters. No additional hardware circuit or sophisticated transient controller is required to perform the LVRT function with the disclosed two methods. In addition, no complex and time-consuming controller parameter design process is required. Therefore, the system cost and control complexity can be significantly reduced.

Both disclosed methods comprise unique advantages, including but not limited to: (1) no voltage sensors are required; (2) with or without PLL; (3) no extra hardware circuit are required; (4) a unified control for both LVRT and steady state; (5) very fast dynamics and high control bandwidth.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates a control block diagram for a finite control set (FCS) model predictive control (MPC) for a PLL-less SiC grid-tied Inverter with Zero-Voltage-Ride-Through (ZVRT) capability.

FIG. 1B illustrates the equivalent circuit model of the FCS-MPC of FIG. 1A where L_{f} represent the filter and grid inductance, and R_{f} is the parasitic resistance.

FIG. 1C illustrates exemplary inverter output voltage vectors for an inverter using the MPC method disclosed herein.

FIG. 2A illustrates simulation results of traditional inverter control with phase lock loop (PLL).

FIG. 2B illustrates simulation results with an embodiment of the disclosed MPC controller.

FIG. 3A illustrates ZVRT simulation results for an inverter controlled at the constant current mode during the ZVRT using traditional methods.

FIG. 3B illustrates ZVRT simulation results for an inverter controlled using embodiments of the disclosed MPC method.

FIG. 4 illustrates an exemplary 10 kW SiC inverter prototype used to run simulations of the disclosed methods.

FIG. 5A illustrates waveforms of the transition from standalone to grid-tied mode of a traditional grid-tied inverter control.

FIG. 5B illustrates waveforms of the transition from standalone to grid-tied mode of embodiments of the disclosed MPC inverter control.

FIG. 6A illustrates steady-state results under standalone mode of embodiments of the disclosed MPC method.

FIG. 6B illustrates steady-state results under grid-tied mode of embodiments of the disclosed MPC method.

FIG. 7A illustrates the control block diagram of embodiments of deadbeat-based predictive control for a SiC grid-tied inverter with L filter which can predict the grid voltage and conduct the direct power control, thus eliminating the need for PLL and voltage sensors.

FIG. 7B illustrates the equivalent circuit model of embodiments of deadbeat-based predictive control where Ls includes both the filter and grid inductance, Rₛ is the parasitic resistance.

FIG. 7C illustrates a graph showing the operating principle of embodiments of the disclosed deadbeat controller.

FIG. 8 illustrates simulation results of a 480V/60 Hz 50 kW inverter with deadbeat-based predictive control under L_{g}=0, L_{f}=800 μH, 1000 Vdc, fs=50 kH, and Rₛ=0.05Ω without PLL and voltage sensors.

FIG. 9 illustrates the derived current tracking errors under different grid inductances. The x-axis denotes the ratio between the grid inductance L_{g} and filter inductance L_{f}. And the y-axis represents the per-unit error between the grid current and its reference.

FIG. 10A illustrates simulation results of embodiments of the deadbeat predictive control method without robust grid voltage prediction using same simulation parameters of FIG. 8, but under large grid impedance, i.e., L_{g}=2 mH.

FIG. 10B illustrates simulation results of embodiments of the deadbeat predictive control method with robust grid voltage prediction using same simulation parameters of FIG. 8, but under large grid impedance, i.e., L_{g}=2 mH.

FIG. 11A illustrates grid-tied experimental results of embodiments of the disclosed deadbeat predictive control method under large grid inductance (L_{g}≈2 mH=5% Z_{base}) without robust grid voltage prediction.

FIG. 11B illustrates grid-tied experimental results of embodiments of the disclosed deadbeat predictive control method under large grid inductance (L_{g}≈2 mH=5% Z_{base}) with robust grid voltage prediction.

FIG. 12A illustrates experimental results of a 100 VAC to 50 VAC LVRT using a traditional LVRT control method with voltage sensors and PLL.

FIG. 12B illustrates experimental results of a 100 VAC to 50VAC LVRT using embodiments of deadbeat predictive control with voltage sensor-less and PLL-less.

FIG. 13 illustrates an example computing device that may be used to practice aspects described herein.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising”, and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. As used herein, “exemplary” means an example of and is not intended to denote a preference or a preferred embodiment. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for power electronic conversion and inversion for next generation renewable energy systems and electrified transportation, it will become evident to those skilled in the art that the implementations are not limited thereto.

Systems, devices, and methods are described herein that facilitate using a power electronic circuit (inverter) for inversion and regulation of electrical power. Generally, an inverter changes dc power from a power supply/generator such as a solar photovoltaic array, wind turbine, fuel cells, batteries, microturbines and the like to a single- or poly-phase ac power (e.g., three-phase) for connection to an electrical gid. The methods, systems and devices described herein may be used on Si, SiC, GaN, etc. inverters.

### Model Predictive Control for a PLL-Less Grid-Tied Inverter with Zero-Voltage-Ride-Through Capability

A finite control set model predictive control (FCS-MPC) is disclosed for a poly-phase grid-tied inverter. This disclosed MPC achieves fast dynamics control and zero-voltage-ride-through (ZVRT) capability without PLL and voltage sensors. The disclosed MPC is first simulated and compared with traditional control with PLL. It is then implemented in an exemplary 10 kW SiC inverter with 50 kHz sampling frequency where the simulation results and preliminary downscaled experiment results demonstrate the advantages of the disclosed MPC method.

Herein, embodiments of a FCS-MPC method are disclosed for a grid-tied inverter with L filter. The inverter model and MPC control equation are derived herein to achieve a stable grid-tied control without PLL and voltage sensors. Moreover, the disclosed control allows ZVRT capability implemented with fast dynamics and low inrush current, which further improves the reliability of the grid-tied inverters. Simulation results and preliminary experiment results are presented and compared with those from traditional control with PLL to demonstrate the advantages of the disclosed MPC method.

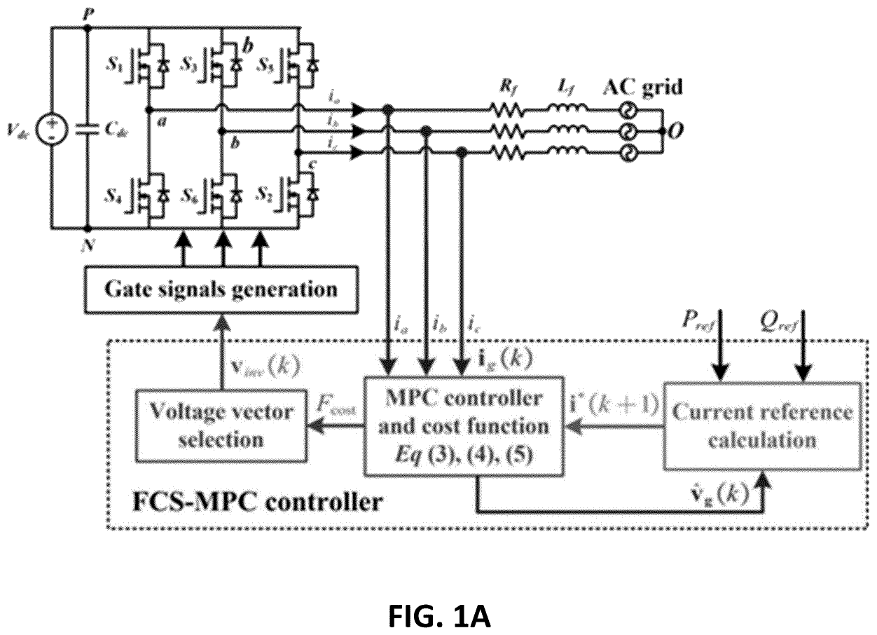

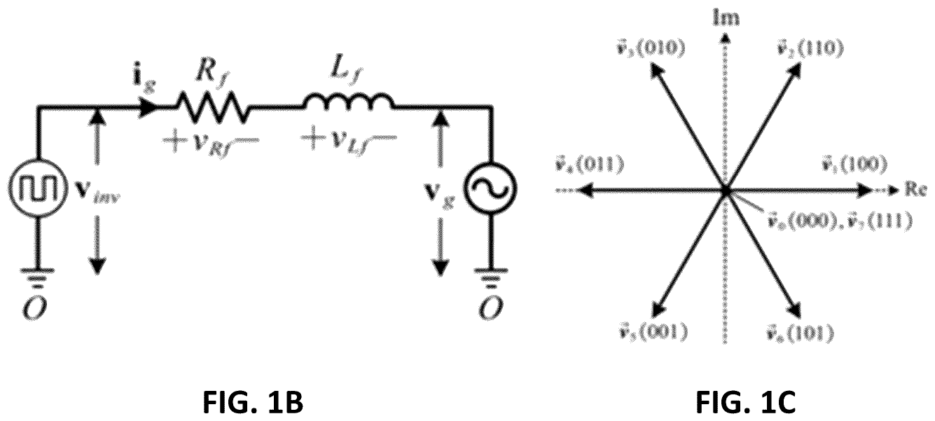

An example of the disclosed FCS-MPC control for a grid-tied inverter with L filter is presented in FIGS. 1A-1C, where FIG. 1A shows the control block diagram, FIG. 1B is the equivalent circuit model where L_{f} represent the filter and grid inductance, and R_{f} is the parasitic resistance. The inverter output voltage vectors are shown in FIG. 1C. Both PLL and voltage sensors are removed with the shown example of the MPC method. At kth sampling instant, the reference i*(k+1) is calculated and the current i_{g}(k) is measured. The MPC controller predicts the future current value with seven possible vectors and evaluate them using the cost function. Then, the optimal voltage vector is selected to minimize the cost function.

The mathematical equation can be derived from equivalent circuit model and established in (1):

$${L}_{f} \frac{{di}_{g}}{dt} = {v}_{inv} - {R}_{f} \cdot {i}_{g} - {v}_{g} \qquad ( 1 )$$

where i_{g} and vᵢₙᵥ are the grid current and inverter voltage, v_{g} is the grid voltage. The discrete-time model with the sampling time Tₛₐₘₚ can be derived with the forward Euler method.

$$\frac{{di}_{g}}{dt} = \frac{{i}_{g} ( k + 1 ) - {i}_{g} ( k )}{{T}_{samp}} \qquad ( 2 )$$

$${\hat{i}}_{g} ( k + 1 ) = \frac{{T}_{samp}}{{L}_{f}} ( {v}_{inv} ( k ) - {\hat{v}}_{g} ( k ) ) + ( 1 - \frac{{R}_{f} \cdot {T}_{samp}}{L} ) {i}_{g} ( k ) \qquad ( 3 )$$

where i_{g}(k) and \hat{v}_{g}(k) denote the current and grid voltage in the present sampling cycle, and vᵢₙᵥ(k) refers to the inverter output voltage in this cycle, and i_{g}(k+1) is the predicted current at next sampling cycle.

Since the sampling frequency is much higher than grid frequency, it is assumed that the grid voltage does not change considerably in one sampling cycle. As a result, the \hat{v}_{g}(k) can be predicted in (4).

$${\hat{v}}_{g} ( k ) = {\hat{v}}_{g} ( k - 1 ) = - \frac{L ,}{{T}_{samp}} {i}_{g} ( k ) + ( \frac{{L}_{f}}{{T}_{samp}} - {R}_{f} ) {i}_{g} ( k - 1 ) + {v}_{inv} ( k - 1 ) \qquad ( 4 )$$

In order to evaluate and select an appropriate voltage vector for inverter output, a cost function is developed in (5).

F_{cost}=|iₐ*(k+1)−iₐ^{p}(k+1)|+|i_{b}*(k+1)−i_{b}^{p}(k+1)|+|i_{c}*(k+1)−i_{c}^{p}(k+1)| (5)

where iₐ*(k+1), i_{b}*(k+1), i_{c}*(k+1) are the calculated future current references, and iₐ^{p}(k+1), i_{b}^{p}(k+1), i_{c}^{p}(k+1) are the predicted future current values from (3).

It is to be noted that ZVRT can be achieved seamlessly using the same control law instead of a specially designed control to mitigate the inrush current, which is different from other control methods. For example, a hardware-based control is conventionally required to suppress the high inrush current. With the disclosed method, such a meticulously designed transient controller is not required to suppress the current overshoot in the ZVRT transients even when the grid interface filter is small.

In order to evaluate the performance of the disclosed FCS-MPC method, the simulation of an exemplary 50 kW grid-tied inverter is conducted with following parameters: AC grid is 480 VAC/60 Hz, DC voltage is 1000V, sampling frequency is 50 kHz, L_{f} and R_{f} of the L filter are 500 μH and 0.05Ω, respectively.

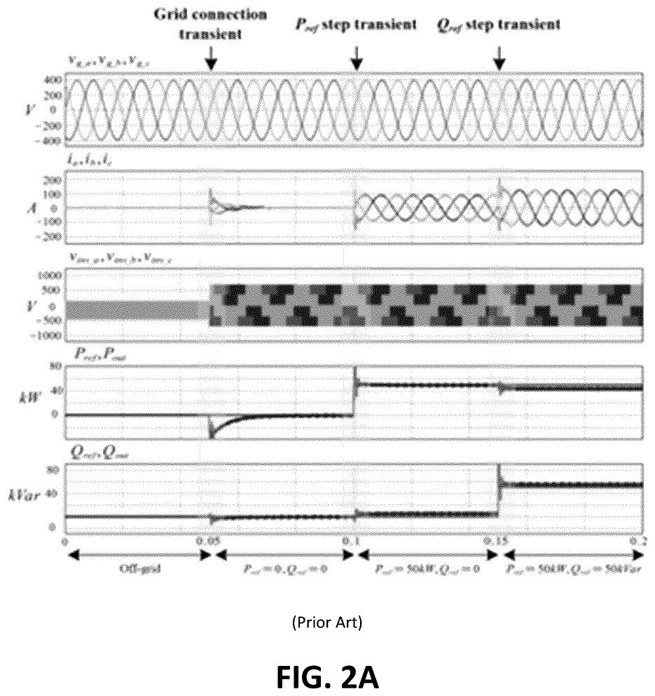

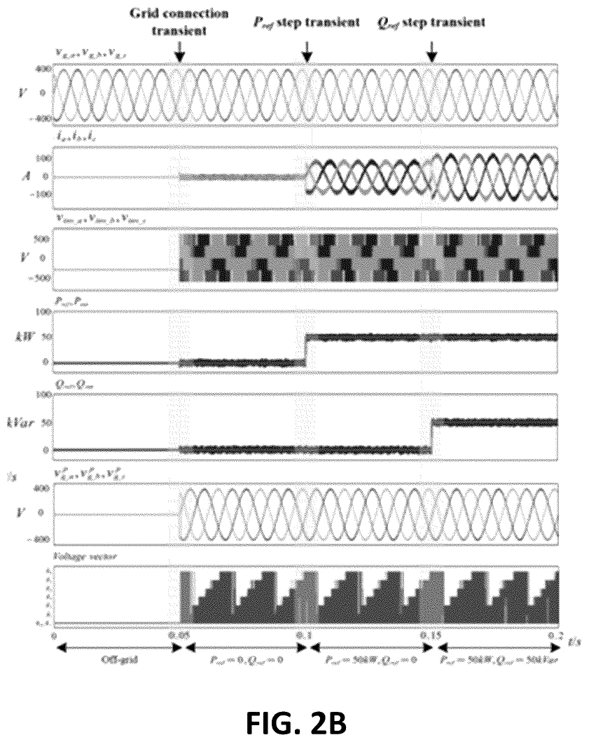

FIG. 2A shows the simulation results of traditional control with PLL. The inverter is connected to the grid at t=0.05 s. Then, the P_{ref} changes from 0 to 50 kW at t=0.1 s, and the Q_{ref} changes from 0 to 50 k Var at t=0.15 s. There are large current overshoots (up to 2 p.u.) during transients, and it takes long time, i.e., several tens of ms, to reach the steady states. P_{ref} and Q_{ref} are used to calculate the current reference. P_{ref} is the real power reference, and the Q_{ref} is the reactive power reference. They are the references/control objectives of the grid-tied inverter to generate the real power and reactive power and then transfer to the ac grid. In the disclosed embodiments, predicted grid voltage rather than the measured grid voltage can be used to calculate the current reference.

The simulation results with an embodiment of the disclosed MPC controller are shown in FIG. 2B. Note no PLL or voltage sensors is applied here, instead it predicts grid voltage information and generate desired inverter voltage vectors shown at the bottom of FIG. 2B. As shown, not only is the steady-state current and power well controlled, but also good dynamic performance with fast response is achieved. The inverter tracks the references accurately with short settling times (less than 200 μs).

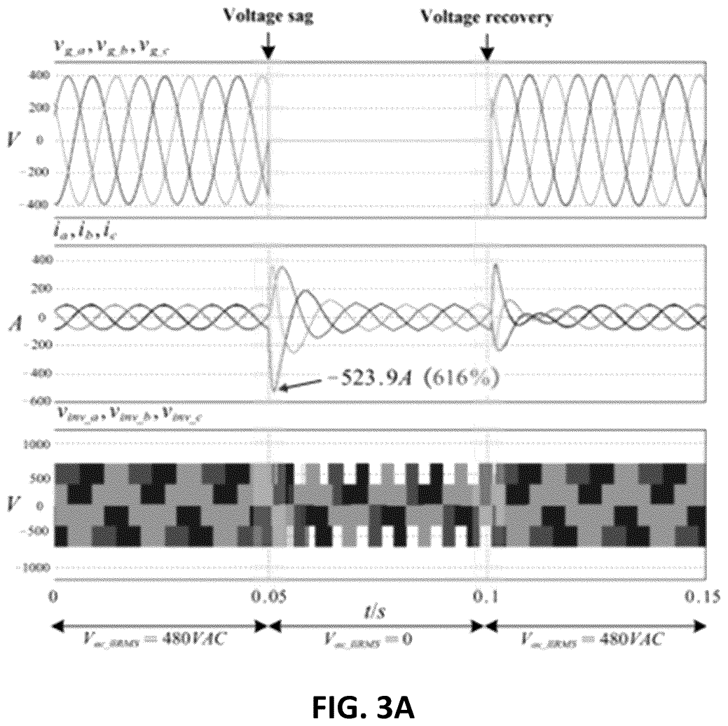

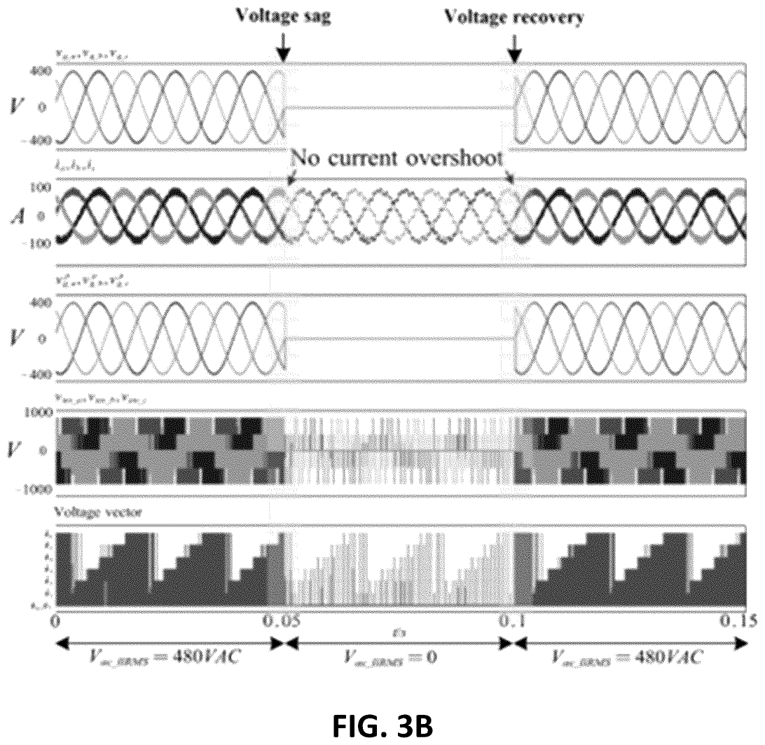

The ZVRT simulation results are shown in FIGS. 3A and 3B. The grid voltage drops to 0 at t=0.05 s and recovers at t=0.1 s. The inverter is controlled at the constant current mode during the ZVRT. The traditional method result is shown in FIG. 3A, the peak current in the transitions is up to 6.16 p.u. In practical applications, such large overshoot may trigger inverter protections and shutdown to fail the ZVRT, so extra design is required to mitigate the inrush current. With the disclosed MPC method, the inverter can achieve fast, stable, and reliable control during the ZVRT, and the transient time and overshoot currents are significantly mitigated, as shown in FIG. 3B. The predicted grid voltage, inverter output voltage and generated inverter voltage vectors of the disclosed MPC are shown at 3^{rd}, 4^{th} and 5^{th} rows (from the top) of FIG. 3B, respectively. The real grid voltage and current are presented in rows 1 and 2 (at the top) of FIG. 3B.

The LVRT dynamic performance of the disclosed “FCS-MPC LVRT approach” include:
Grid voltage drop 20% (LVRT): response time is ˜120 μs (6 sampling cycles, sampling frequency is 50 kHz), ˜0.72% of the line cycle (60 Hz line frequency).
Grid voltage drop 50% (LVRT): response time is ˜140 μs (7 sampling cycles, sampling frequency is 50 kHz), ˜0.84% of the line cycle (60 Hz line frequency).
Grid voltage drop 100% (ZVRT): response time is ˜200 μs (10 sampling cycles, sampling frequency is 50 kHz), ˜1.2% of the line cycle (60 Hz line frequency).

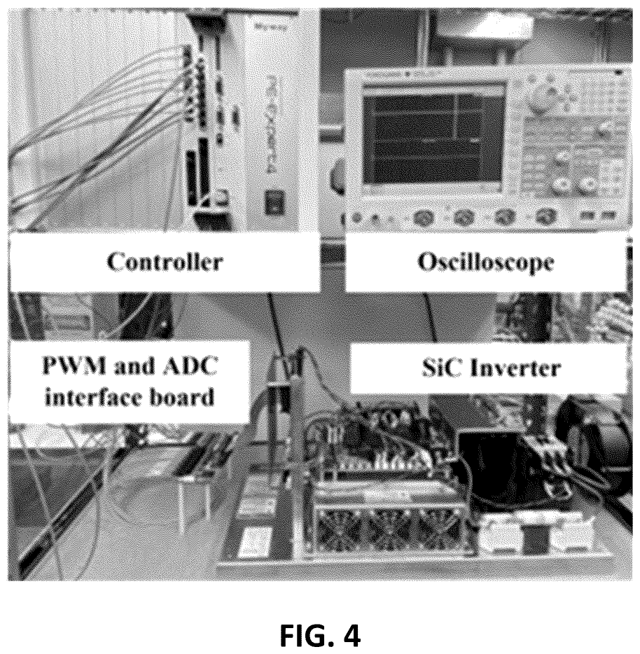

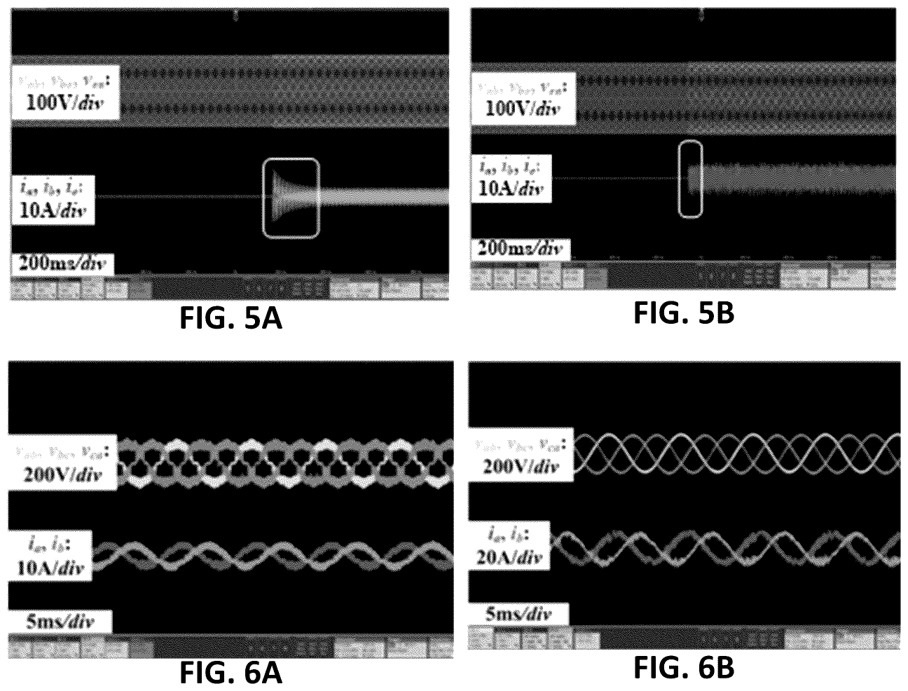

The down-scaled grid-tied experiment are conducted, and the 10 kW SiC inverter prototype is shown in the images of FIG. 4. The grid line-to-line RMS voltage is set to 200 VAC. And the grid interface inductance is 800 μH. FIGS. 5A and 5B show the waveforms of the transition from standalone to grid-tied mode. Compared with traditional control, the disclosed MPC method allows the fast response meanwhile to effectively reduce the overcurrent and oscillations during the grid synchronization transient. FIGS. 6A and 6B show the steady-state results under standalone and grid-tied mode respectively. The effectiveness of the disclosed PLL-less MPC approach is therefore verified.

### Deadbeat Control

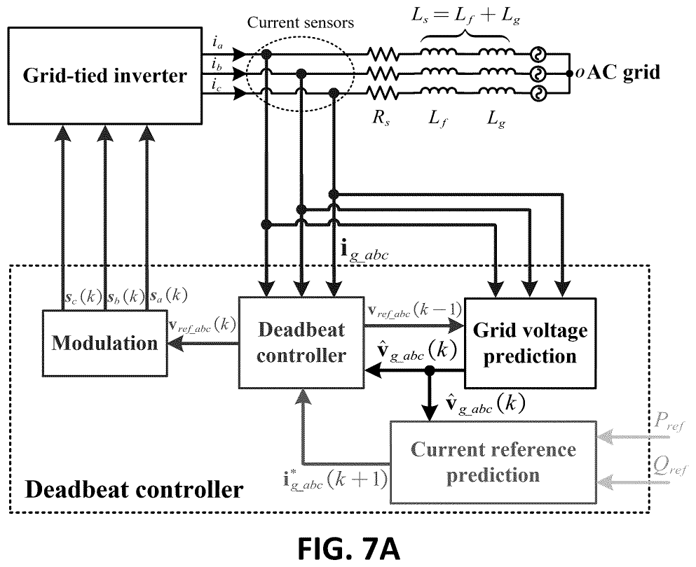

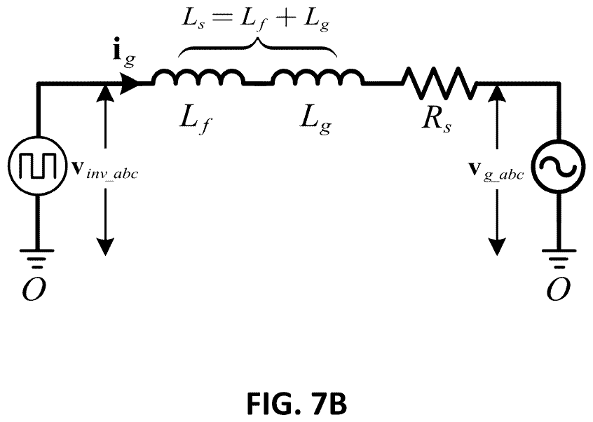

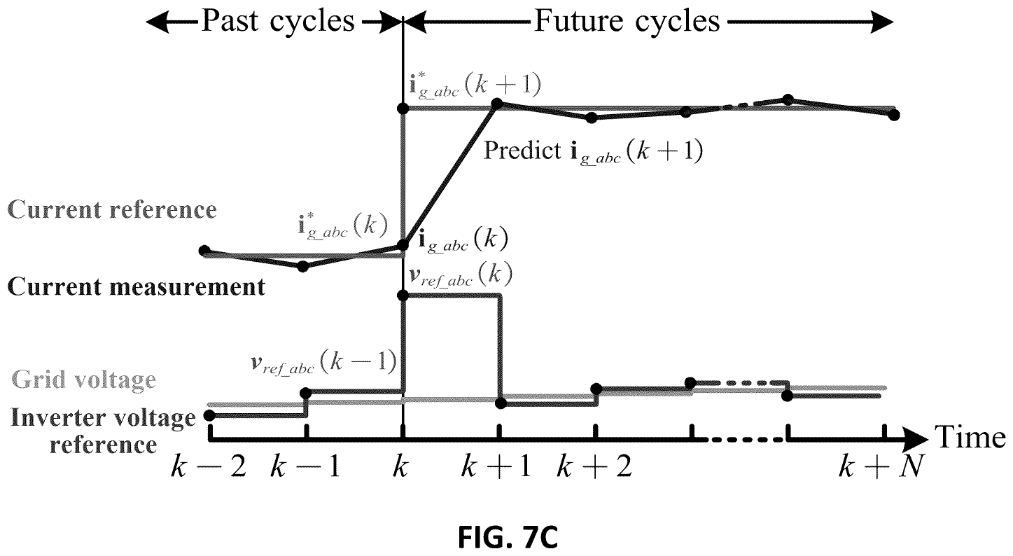

FIGS. 7A-7C illustrate a grid-tied inverter with L filter having a deadbeat-based predictive controller. FIG. 7A shows the control block diagram, which predicts the grid voltage and conducts the direct power control, thus eliminating the need for PLL and voltage sensors. FIG. 7B is the equivalent circuit model where Lₛ includes both the filter and grid inductance, Rₛ is the parasitic resistance. The operating principle of the disclosed deadbeat controller is presented in FIG. IC. At k^{th} sampling cycle, the grid currents are measured. The sensed currents are utilized to predict the grid voltage in (6) to achieve voltage sensor-less feature in the disclosed control.

$${\hat{v}}_{g\_abc} ( k ) \approx {\hat{v}}_{g\_abc} ( k - 1 ) = - \frac{{L}_{s}}{{T}_{s}} {i}_{g\_abc} ( k ) + ( \frac{{L}_{s}}{{T}_{s}} - {R}_{s} ) {i}_{g\_abc} ( k - 1 ) + {v}_{ref\_abc} ( k - 1 ) \qquad ( 6 )$$

where i_{g_abc} are sensed grid currents, v_{ref_abc} are inverter voltage references, and \hat{v}_{g_abc}(k) are the predicted grid voltages in abc-frame. Tₛ is the sampling cycle, which is same as switching cycle in the disclosed deadbeat method.

The derived predicted grid voltage and P_{ref}, Q_{ref} are then sent to current reference prediction block as shown in FIG. 7A to generate the next cycle current reference using (7):

$${i}_{g \_αβ}^{*} ( k + 1 ) = [ \begin{matrix}{i}_{α}^{*} ( k + 1 ) \\ {i}_{β}^{*} ( k + 1 )\end{matrix} ] = \frac{2}{3 {\vert {\hat{v}}_{g αβ} ( k ) \vert}^{2}} \cdot [ \begin{matrix}{\hat{v}}_{g α} ( k ) & - {\hat{v}}_{g β} ( k ) \\ {\hat{v}}_{g β} ( k ) & {\hat{v}}_{g α} ( k )\end{matrix} ] \cdot [ \begin{matrix}{P}_{ref} \\ {Q}_{ref}\end{matrix} ] \qquad ( 7 )$$

where i_{g_αβ}*(k+1) is the future current reference in αβ-frame, P_{ref}, Q_{ref} are the power references of the grid-tied inverter, \hat{v}_{gα}, \hat{v}_{gβ} and i_{gα}, i_{gβ} are predicted grid voltages and measured grid currents in aft-frame respectively. The disclosed deadbeat controller responds to the current references in one switching cycle and generates the desired inverter voltage references without PLL. The desired inverter output voltage reference can be derived in (8) from the grid-tied inverter circuit model of FIG. 7B:

$${v}_{ref\_abc} ( k ) = {L}_{s} \cdot \frac{{i}_{g\_abc}^{*} ( k + 1 ) - {i}_{g\_abc} ( k )}{{T}_{s}} + {R}_{s} \cdot {i}_{g\_abc} ( k ) + {\hat{v}}_{g\_abc} ( k ) \qquad ( 8 )$$

where i_{g_abc}(k), v_{ref_abc}(k), and \hat{v}_{g_abc}(k) denote the grid current, inverter voltage reference, and the predicted grid voltage in the present sampling cycle, and i_{g_abc}(k+1) refers to the grid current at the next sampling cycle.

The voltage reference is then sent to the modulation block to generate the PWM signals to control the inverter switches. It is to be noted that ZVRT can be achieved seamlessly using the same deadbeat control algorithm instead of a meticulously designed transient controller to suppress the large inrush current overshoot.

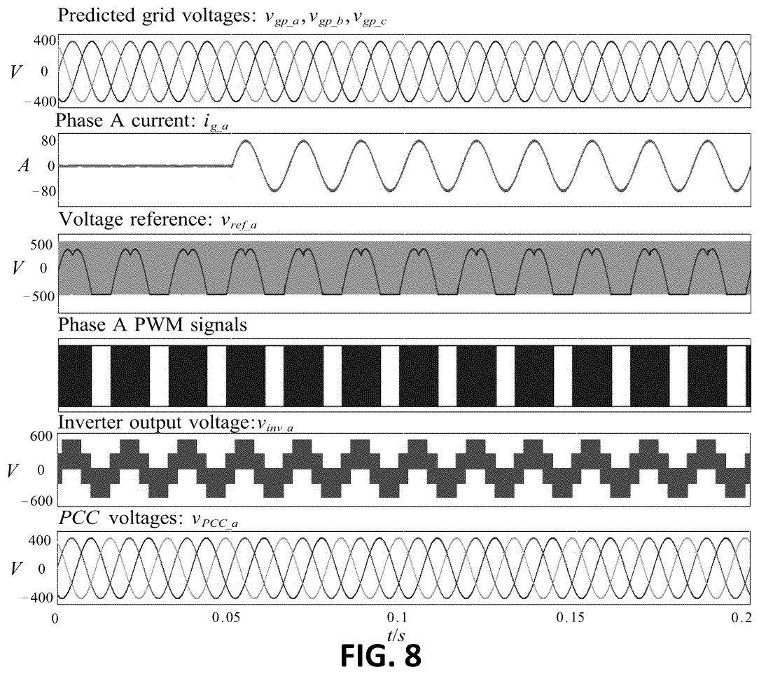

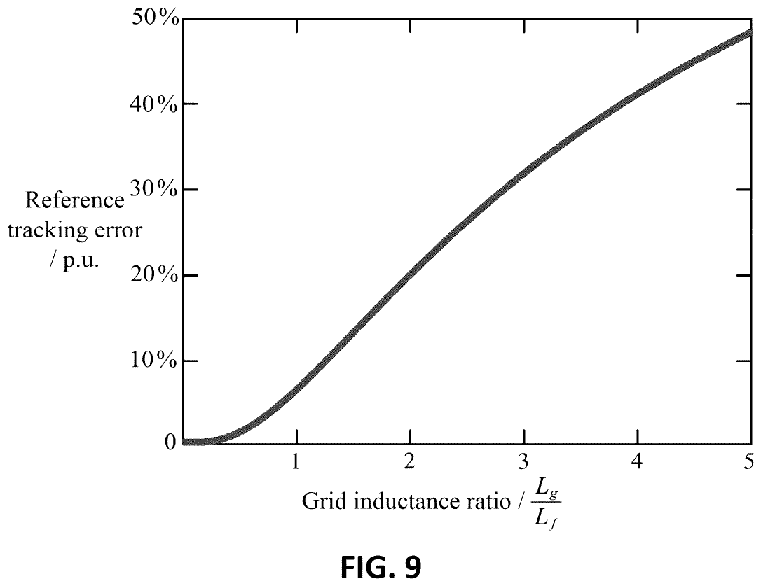

The voltage sensor-less and PLL-less grid-tied inverter can achieve good performance under zero or small grid inductance L_{g}, which is demonstrated in simulation results of FIG. 8 where rated power is enabled at t=0.05 s. However, the control performance may be degraded when the grid inductance L_{g} is not negligible and cannot be predicted accurately. FIG. 9 presents the derived current tracking errors under different grid inductances. The x-axis denotes the ratio between the grid inductance L_{g} and filter inductance L_{f}. And the y-axis represents the per-unit error between the grid current and its reference. It can be concluded that with the increase of grid inductance, the current tracking performance has larger tracking error.

To improve the performance of the disclosed deadbeat method under different grid impedance, a robust grid voltage prediction method is introduced in (9):

$${\hat{v}}_{g\_abc}^{′} ( k ) = \frac{2 π {f}_{d} {T}_{s}}{1 + 2 π {f}_{d} {T}_{s}} {\hat{v}}_{g\_abc} ( k ) + \frac{1}{1 + 2 π {f}_{d} {T}_{s}} {\hat{v}}_{g\_abc}^{′} ( k - 1 ) \qquad ( 9 )$$

where \hat{v}_{g_abc}(k) is the original predicted grid voltages, and f_{d} is the design variable to improve the robustness.

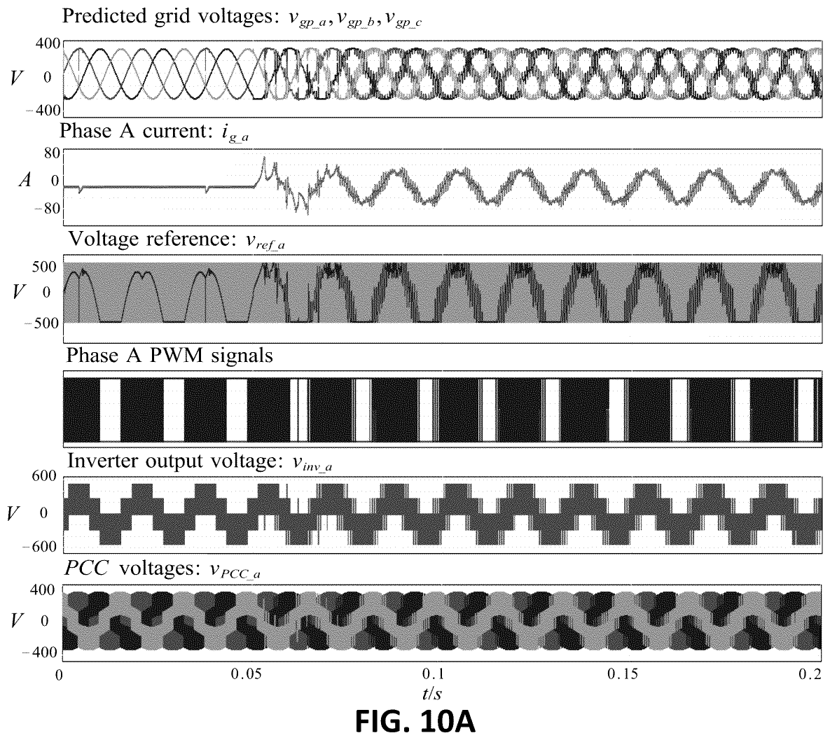

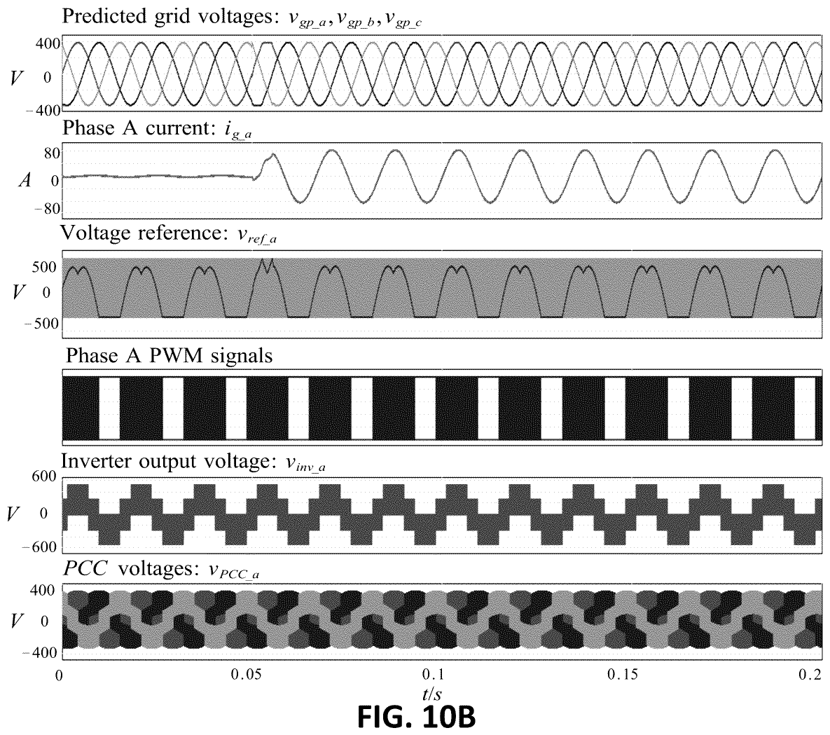

FIGS. 10A and 10B show the simulation results of the disclosed deadbeat method with and without robust grid voltage prediction using the same simulation parameters of FIG. 8 but under large grid impedance, i.e., L_{g}=2 mH. It can be observed that the predicted grid voltages have large distortion if original voltage prediction method is applied, leading to a poorly controlled grid current with large steady-state tracking error. On the other hand, the grid voltage can be better predicted, and the grid current can be well-controlled with the improved method. Therefore, the robustness and stability of the grid-tied inverter is enhanced.

As before (see FIG. 4), an exemplary 10 kW 3-phase SiC inverter hardware is utilized to verify the advantages of the disclosed deadbeat control, where v_{ac} is 400 VAC/60 Hz, v_{dc} is 700V, fₛ is 50 kHz, L_{f} of the L filter is 800 μH (2% Z_{base}) and Rₛ is 0.05Ω.

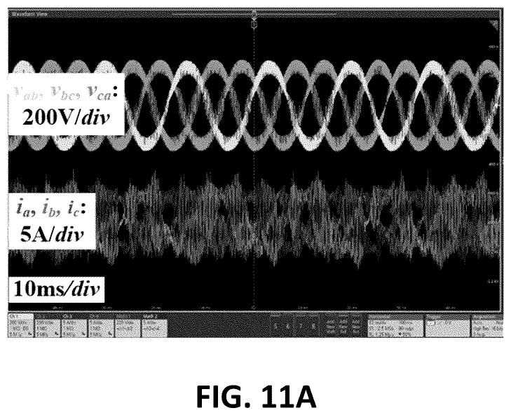

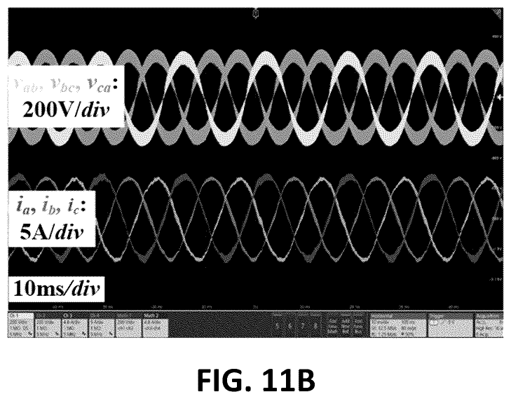

FIGS. 11A and 11B show the grid-tied experimental results of the disclosed deadbeat under large grid inductance (L_{g}=2 mH=5% Z_{base}). FIG. 11A presents the results without robust grid voltage prediction. It can be observed that the grid currents have large harmonics and tracking errors, which is consistent with the simulation results in FIG. 10A. FIG. 11B shows the result with the improved grid voltage prediction. The grid currents are well controlled with reduced tracking errors. The grid-tied inverter robustness and performance are significantly improved.

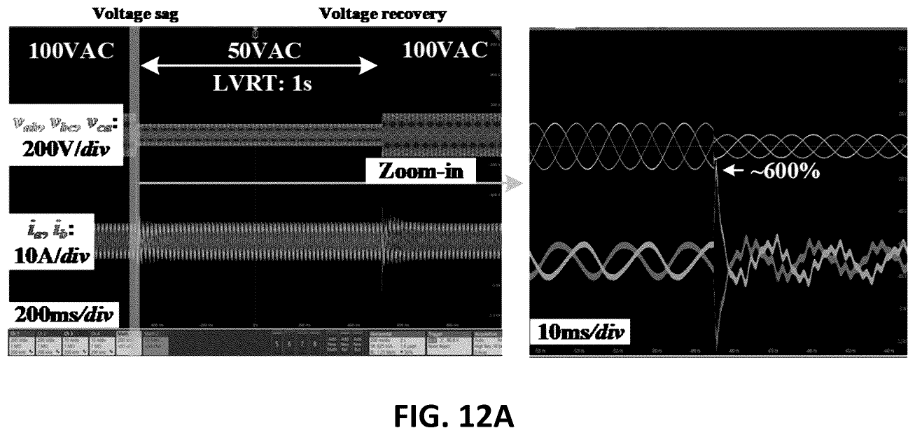

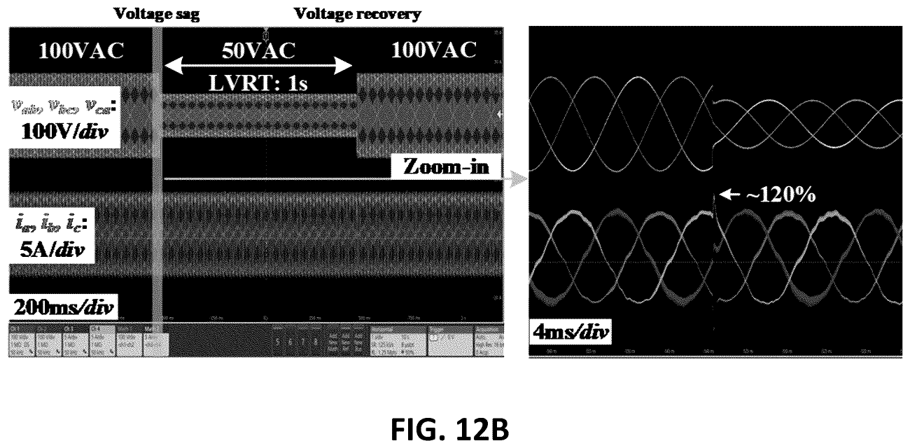

The experimental result of a 100 VAC to 50 VAC LVRT using the traditional LVRT control method with voltage sensors and PLL is compared with that of disclosed deadbeat method is shown in FIGS. 12A and 12B. The experiments are conducted using a grid emulator and the inverter is controlled at the constant current mode during the LVRT steady state. Because deadbeat control facilitates smaller transients, the voltage and current scales are adjusted smaller in the FIG. 12B. It can be found that there are large current overshoots (up to ˜6 p.u.) during the LVRT transients with traditional method. In addition, the grid currents are poorly controlled for several line cycles after the LVRT transients. With the disclosed robust deadbeat control method, the inverter can achieve fast, stable, and reliable control during LVRT, and the transient time and overshoot currents are significantly mitigated.

The LVRT dynamic performance of the disclosed “deadbeat LVRT approach” include:
Grid voltage drop 20% (LVRT): response time is ˜100 μs (5 sampling cycles, sampling frequency is 50 kHz), ˜0.6% of the line cycle (60 Hz line frequency).
Grid voltage drop 50% (LVRT): response time is ˜120 μs (6 sampling cycles, sampling frequency is 50 kHz), ˜0.72% of the line cycle (60 Hz line frequency).
Grid voltage drop 100% (ZVRT): ˜160 μs (8 sampling cycles, sampling frequency is 50 kHz), ˜1.2% of the line cycle (60 Hz line frequency).

The LVRT dynamic performance of embodiments of the two disclosed approaches are similar. The response time are in the range of 100 μs˜200 μs (5˜10 sampling cycles), 0.6%˜1.2% of the line cycle (60 Hz line frequency). While other LVRT methods normally need several tens of millisecond to finish the LVRT control.

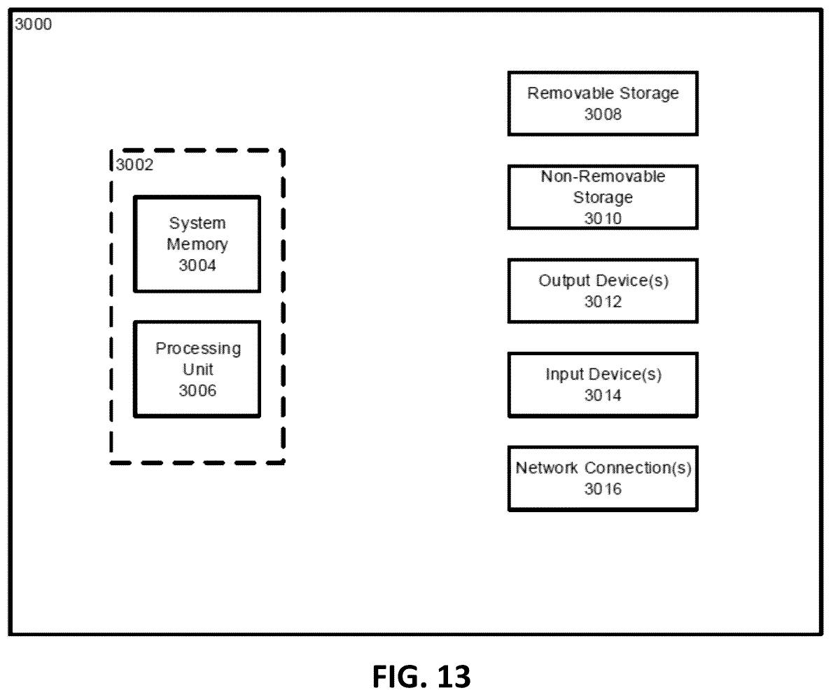

It should be appreciated that the logical operations described herein with respect to the various figures may be implemented (1) as a sequence of computer implemented acts or program modules (i.e., software) running on a computing device (e.g., the computing device described in FIG. 13), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 13, an example computing device 3000 upon which embodiments of the invention may be implemented is illustrated. It should be understood that the example computing device 3000 is only one example of a suitable computing environment upon which embodiments of the invention may be implemented. Optionally, the computing device 3000 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media. The disclosed computing device 3000 may comprise all or a part of the controller used to implement the above-described methods of inverter control.

In its most basic configuration, computing device 3000 typically includes at least one processing unit 3006 and system memory 3004. Depending on the exact configuration and type of computing device, system memory 3004 may be volatile (such as random-access memory (RAM)), non-volatile (such as read-only memory (ROM), flash memory, etc.), or some combination of the two. This most basic configuration is illustrated in FIG. 30 by dashed line 3002. The processing unit 3006 may be a standard programmable processor that performs arithmetic and logic operations necessary for operation of the computing device 3000. The computing device 3000 may also include a bus or other communication mechanism for communicating information among various components of the computing device 3000.

Computing device 3000 may have additional features/functionality. For example, computing device 3000 may include additional storage such as removable storage 3008 and non-removable storage 3010 including, but not limited to, magnetic or optical disks or tapes. Computing device 3000 may also contain network connection(s) 3016 that allow the device to communicate with other devices. Computing device 3000 may also have input device(s) 3014 such as a keyboard, mouse, touch screen, etc. Output device(s) 3012 such as a display, speakers, printer, etc. may also be included. The additional devices may be connected to the bus in order to facilitate communication of data among the components of the computing device 3000. All these devices are well known in the art and need not be discussed at length here.

The processing unit 3006 may be configured to execute program code encoded in tangible, computer-readable media. Tangible, computer-readable media refers to any media that is capable of providing data that causes the computing device 3000 (i.e., a machine) to operate in a particular fashion. Various computer-readable media may be utilized to provide instructions to the processing unit 3006 for execution. Example tangible, computer-readable media may include, but is not limited to, volatile media, non-volatile media, removable media and non-removable media implemented in any method or technology for storage of information such as computer readable instructions, data structures, program modules or other data. System memory 3004, removable storage 3008, and non-removable storage 3010 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 3006 may execute program code stored in the system memory 3004. For example, the bus may carry data to the system memory 3004, from which the processing unit 3006 receives and executes instructions. The data received by the system memory 3004 may optionally be stored on the removable storage 3008 or the non-removable storage 3010 before or after execution by the processing unit 3006.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A Model Predictive Control (MPC) method for a Grid-Tied Inverter with Zero-Voltage-Ride-Through (ZVRT) Capability, comprising:
calculating, by a controller, at a kth sampling instant, a current reference i*(k+1) using P_{ref} (real-power reference) and Q_{ref} (reactive power reference)
measuring, by the controller, at the kth sampling instant, a grid current i_{g}(k);
predicting, by the controller, a future current value with a plurality of possible vectors, wherein the future current value is predicted using a predicted grid voltage rather than a measured grid voltage;
evaluating, by the MPC controller, each of the plurality of possible vectors, in a cost function;
selecting, by the controller, a voltage vector to minimize the cost function; and
generating, by the controller, gate signals for the inverter using the selected voltage vector.

2. The method of claim 1, wherein
$${\hat{i}}_{g} ( k + 1 ) = \frac{{T}_{samp}}{{L}_{f}} ( {v}_{inv} ( k ) - {\hat{v}}_{g} ( k ) ) + ( 1 - \frac{{R}_{f} \cdot {T}_{samp}}{L} ) {i}_{g} ( k ) ,$$
where i_{g}(k) and \hat{v}_{g}(k) denote a current and a grid voltage in a present sampling cycle, and vᵢₙᵥ(k) refers to a inverter output voltage in this cycle, and î_{g}(k+1) is a predicted current at a next sampling cycle, where i_{g} and vᵢₙᵥ are grid current and inverter voltage, v_{g} is a grid voltage, and Tₛₐₘₚ is sampling frequency, where L_{f} represent a filter and a grid inductance, and R_{f} is a parasitic resistance of the filter.

3. The method of claim 2, wherein the sampling frequency is much greater than a frequency of the grid.

4. The method of claim 3, wherein the grid frequency is 60 Hz.

5. The method of claim 3, wherein the sampling frequency is 50 kHz.

6. The method of claim 3, wherein it is assumed that the grid voltage does not change considerably in one sampling cycle and the \hat{v}_{g}(k) can be predicted as:
$${\hat{v}}_{g} ( k ) = {\hat{v}}_{g} ( k - 1 ) = - \frac{{L}_{f}}{{T}_{samp}} {i}_{g} ( k ) + ( \frac{{L}_{f}}{{T}_{samp}} - {R}_{f} ) {i}_{g} ( k - 1 ) + {v}_{inv} ( k - 1 ) .$$

7. The method of claim 6, wherein the cost function comprises F_{cost}=|iₐ*(k+1)−iₐ^{p}(k+1)|+|i_{b}*(k+1)−i_{b}^{p}(k+1)|+|i_{c}*(k+1)−i_{c}^{p}(k+1), where iₐ*(k+1), i_{b}*(k+1), i_{c}*(k+1) are the calculated future current references, and iₐ^{p}(k+1), i_{b}^{p}(k+1), i_{c}^{p}(k+1) are the predicted future current values.

8. The method of claim 1, wherein the plurality of possible vectors comprises seven possible vectors.

9. The method of claim 1, wherein the inverter is a Si, SiC, or GaN inverter.

10. The method of claim 1, wherein when the grid voltage drop is approximately 20% (LVRT), a controller response time is ˜120 μs (6 sampling cycles, sampling frequency is 50 kHz), ˜0.72% of the line cycle (60 Hz line frequency); when the grid voltage drop is approximately 50% (LVRT), the controller response time is ˜140 μs (7 sampling cycles, sampling frequency is 50 kHz), ˜0.84% of the line cycle (60Hz line frequency); and when the grid voltage drop is approximately 100% (ZVRT), the controller response time is 200 μs (10 sampling cycles, sampling frequency is 50 kHz), ˜1.2% of the line cycle (60 Hz line frequency).

11. The method of claim 1, wherein the inverter does not utilize a Phase Lock Loop (PLL) or voltage sensors.

12. A deadbeat control method for a Grid-Tied Inverter with Zero-Voltage-Ride-Through (ZVRT) Capability, comprising:
measuring, by a controller, at a kth sampling instant, a set of a grid current for each phase of the grid;
predicting, by the controller, a grid voltage using the grid currents;
generating, by the controller, a next cycle current reference using the predicted grid voltage and P_{ref}, Q_{ref}, a real power reference, and a reactive power reference, respectively;
generating, by the controller, in one switching cycle or less, in response to the current references, desired inverter voltage references; and
generating, by a modulation block of the controller, PWM signals to control inverter switches, wherein the PWM signal are generated by the modulation block based on the desired inverter voltage references.

13. The method of claim 12, wherein the grid voltage is predicted by
$${\hat{v}}_{g\_abc} ( k ) \approx {\hat{v}}_{g\_abc} ( k - 1 ) = - \frac{{L}_{s}}{{T}_{s}} {i}_{g\_abc} ( k ) + ( \frac{{L}_{s}}{{T}_{s}} - {R}_{s} ) {i}_{g\_abc} ( k - 1 ) + {v}_{ref\_abc} ( k - 1 ) ,$$
where i_{g_abc} are sensed grid currents, v_{ref_abc} are inverter voltage references, and \hat{v}_{g_abc}(k) are predicted grid voltages in abc-frame, Tₛ is a sampling cycle, which is same as the switching cycle.

14. The method of claim 13, wherein the next cycle current reference is predicted using
$${i}_{g \_αβ}^{*} ( k + 1 ) = [ \begin{matrix}{i}_{α}^{*} ( k + 1 ) \\ {i}_{β}^{*} ( k + 1 )\end{matrix} ] = \frac{2}{3 {\vert {\hat{v}}_{g αβ} ( k ) \vert}^{2}} \cdot [ \begin{matrix}{\hat{v}}_{g α} ( k ) & - {\hat{v}}_{g β} ( k ) \\ {\hat{v}}_{g β} ( k ) & {\hat{v}}_{g α} ( k )\end{matrix} ] \cdot [ \begin{matrix}{P}_{ref} \\ {Q}_{ref}\end{matrix} ] ,$$
where i_{g_αβ}(k+1) is the future current reference in αβ-frame, P_{ref}, Q_{ref} are power references of the grid-tied inverter, \hat{v}_{gα} and \hat{v}_{gβ} are predicted grid voltages and measured grid currents in αβ-frame respectively.

15. The method of claim 14, wherein the desired inverter output voltage references are derived using
$${v}_{ref\_abc} ( k ) = {L}_{s} \cdot \frac{{i}_{g\_abc}^{*} ( k + 1 ) - {i}_{g\_abc} ( k )}{{T}_{s}} + {R}_{s} \cdot {i}_{g\_abc} ( k ) + {\hat{v}}_{g\_abc} ( k ) ,$$
where i_{g_abc}(k), v_{ref_abc}(k), and \hat{v}_{g_abc}(k) denote the grid current, inverter voltage reference, and the predicted grid voltage in the present sampling cycle, and i_{g_abc}(k+1) refers to the grid current at the next sampling cycle.

16. The method of claim 12, wherein when the grid voltage drop is approximately 20% (LVRT), a controller response time is ˜100 μs (5 sampling cycles, sampling frequency is 50 kHz), ˜0.60% of the line cycle (60 Hz line frequency); when the grid voltage drop is approximately 50% (LVRT), the controller response time is ˜120 μs (6 sampling cycles, sampling frequency is 50 kHz), ˜0.72% of the line cycle (60 Hz line frequency); and when the grid voltage drop is approximately 100% (ZVRT), the controller response time is 160 μs (8 sampling cycles, sampling frequency is 50 kHz), ˜1.2% of the line cycle (60 Hz line frequency).
